(19) United States
(12) Patent Application Publication
(10) Pub. No.: US 2025/0252769 A1
(43) Pub. Date: Aug. 7, 2025

(54) EXTRACTION OF DOCUMENT CONTENT USING ATTRIBUTE IDENTIFICATION

(71) Applicant: ABBYY Development Inc., Dover, DE (US)

(72) Inventors: Stanislav Semenov, Moscow (RU); Roman Cherkezov, Moscow (RU)

(21) Appl. No.: 18/434,629

(22) Filed: Feb. 6, 2024

(51) Int. Cl. G06V 30/416; G06N 20/00; G06V 10/82; G06V 30/19; G06V 30/413

(52) U.S. Cl. CPC G06V 30/416; G06N 20/00; G06V 10/82; G06V 30/1914; G06V 30/1916; G06V 30/1918; G06V 30/413

(57) ABSTRACT

Aspects and implementations provide for techniques of fast and efficient recognition of texts in electronic documents. The disclosed techniques include, for example, processing, a document to obtain a first (second, etc.) set of hypotheses each associating the document with a respective value of a first (second, etc.) document attribute, form a combined hypotheses each including hypotheses of the first set and the second set. The techniques further include identifying a preferred combined hypothesis associating a first value with the first document attribute and a second value with the second document attribute, and extracting, using the first value and the second value, information content of the document.

### TECHNICAL FIELD

The implementations of the disclosure relate generally to computer systems and, more specifically, to systems and methods for extracting textual information contained in documents.

### BACKGROUND

Detection and recognition of textual and non-textual content of electronic documents is an important task in processing, storing, and referencing documents. Documents can be obtained using a variety of techniques including scanning, photographing, digital synthesis, and/or the like. Optical character recognition (OCR) identifies texts (characters, words, phrases, etc.) from rasterized (pixelated) depictions of symbols by identifying reference symbols that most closely resemble symbols depicted in the documents and form words, sentences, and other units of texts of documents.

### SUMMARY OF THE DISCLOSURE

Implementations of the present disclosure are directed to fast and efficient techniques for identification of document attributes without reliance on a database of client-specific documents and attributes.

In one implementation, a method of the disclosure includes processing a representation of a document to obtain a first set of hypotheses each associating the document with a respective value of a first document attribute. The method further includes processing the representation of the document to obtain a second set of hypotheses each associating the document with a respective value of a second document attribute. The method further includes forming a plurality of combined hypotheses each comprising at least a hypothesis of the first set and a hypothesis of the second set. The method further includes identifying a preferred hypothesis from the plurality of combined hypotheses, the preferred hypothesis associating a first value with the first document attribute and a second value with the second document attribute and extracting, using the first value and the second value, information content of the document.

In another implementation, a system of the disclosure includes a memory and a processing device communicatively coupled to the memory. The processing device is to process a representation of a document to obtain a first set of hypotheses each associating the document with a respective value of a first document attribute, and process the representation of the document to obtain a second set of hypotheses each associating the document with a respective value of a second document attribute. The processing device is further to form a plurality of combined hypotheses each comprising at least a hypothesis of the first set and a hypothesis of the second set. The processing device is further to identify a preferred hypothesis from the plurality of combined hypotheses, the preferred hypothesis associating a first value with the first document attribute and a second value with the second document attribute, and extract, using the first value and the second value, information content of the document.

In yet another implementation, a non-transitory computer-readable memory of the disclosure stores instructions that, when executed by a processing device, cause the processing device to perform operations including processing a representation of a document to obtain a first set of hypotheses each associating the document with a respective value of a first document attribute and processing the representation of the document to obtain a second set of hypotheses each associating the document with a respective value of a second document attribute. The operations further include forming a plurality of combined hypotheses each comprising at least a hypothesis of the first set and a hypothesis of the second set. The operations further include identifying a preferred hypothesis from the plurality of combined hypotheses, the preferred hypothesis associating a first value with the first document attribute and a second value with the second document attribute, and extracting, using the first value and the second value, information content of the document.

### BRIEF DESCRIPTION OF THE DRAWINGS

The disclosure will be understood more fully from the detailed description given below and from the accompanying drawings of various implementations of the disclosure. The drawings, however, should not be taken to limit the disclosure to the specific implementations, but are for explanation and understanding only.

FIG. 1 is a block diagram of an example computer system capable of supporting model-based attribute detection and attribute-based content extraction from electronic documents, in accordance with some implementations of the present disclosure.

FIG. 2 illustrates example operations of a document recognition engine that deploys a module-based attribute detector, in accordance with some implementations of the present disclosure.

FIG. 3 illustrates operations of a combined database-based and model-based attribute detection for content extraction from electronic documents, in accordance with some implementations of the present disclosure.

FIG. 4 illustrates example operations of run-time training of a model-based attribute detector, in accordance with some implementations of the present disclosure.

FIG. 5 illustrates example operations of a database verification using a trained model-based attribute detector, in accordance with some implementations of the present disclosure.

FIG. 6 is a flow diagram illustrating an example method of deploying machine learning models to perform attribute detection for efficient information extraction from documents, in accordance with some implementations of the present disclosure.

FIG. 7 depicts an example computer system that can perform any one or more of the methods described herein, in accordance with some implementations of the present disclosure.

### DETAILED DESCRIPTION

OCR is a complex and resource-consuming technology. As a result, maintaining dedicated OCR servers is often inefficient for even large individual companies. Correspondingly, specialized services (e.g., is cloud-based services) often provide OCR functionality to multiple clients (e.g., trading companies, manufacturing companies, shipping companies, and/or the like). Such clients may include large organizations that process millions of documents each day as well as small entities whose needs are limited to 10-20 documents or even fewer. Large volumes of documents processed by large clients can be used to establish a database (DB) that captures attributes of typical documents processed for such clients. Example attributes can include country of origin of a document (e.g., jurisdiction of an entity that created the document, such as an invoice, a purchasing order, etc.), language of the document, geographical and/or banking attributes (e.g., zip codes, BIC, SWIFT, IBANs, etc.) used, currency referenced in the document (e.g., US Dollar, Euro, UK Pound, Japanese Yen, etc.), a date format (with 02.03 possibly standing for “February 3” or “March 2”), and/or the like.

Documents processed by large clients (or on behalf of such clients) can be checked against a DB of previously processed documents to identify various document attributes. Based on the identified attributes, any other relevant information can be extracted from the documents, such as identifying exact quantities of products (e.g., goods and/or services) ordered/purchased, dates of order/purchase/anticipated delivery, prices and/or discounts of the ordered products, paid or still to be paid taxes/fees, applicable end-user agreements, national and international laws and regulations, trading and shipping restrictions, and/or the like.

Maintaining DBs, however, requires significant time and expenses, e.g., updating a DB when new types of documents and/or vendors appear, correcting errors in the DB, deploying and improving DB searching, storing, and retrieval algorithms, and/or the like. DB-based attribute detection may thus be economically infeasible for smaller clients and/or unavailable to new clients that are yet to collect a substantial number of digital documents. Different clients may have to maintain separate DBs since creating DBs that would be usable by multiple clients may be prohibited by confidentiality concerns, laws and regulations, and/or the like.

Aspects and implementations of the present disclosure address the above noted and other challenges of the existing technology by providing for systems and techniques capable of identifying document attributes without relying on large DBs of historical documents. In some implementations, an incoming document undergoes an OCR that converts the image of the document into units of text (letters, numbers, words, and punctuation marks. The OCR result of the document processing is then input into attribute-detection models trained to identify individual document attributes. For example, one model can be trained to identify a country associated with the document, e.g., the country where the document originator is incorporated/operating or a country of where an order referenced in the document originates and/or to be executed. Another model may be trained to determine a language of the document. Another model may be trained to identify a name of a vendor, e.g., a vendor that created the document or a vendor who is referenced in the document (e.g., a company to execute an order, ship the order, receive the order, and/or the like). Another model may determine an address of the vendor. Another model may be trained to identify currency referenced by the order. Yet another model may identify a format used to list dates in the order, and/or the like. Various other models may be defined and trained. Some models may be trained to identify a combination of two or more attributes, e.g., the combination of country and currency. Because individual models are trained to solve limited tasks and, correspondingly, look for a relatively low number of ques within documents, the models may operate successfully on documents of very different types, origins, formats, languages, and/or the like. Respectfully, the attribute detection models may be successfully trained using sample documents from multiple vendors even when only a few documents are available from individual vendors. During deployment, the trained models may identify document attributes, followed by attribute-based extraction of relevant target (e.g., client-specific) information from the documents. In those instances, where a model makes an attribute determination with a confidence level that is below some threshold confidence, the identified attributes may be flagged for review (e.g., by a human developer or expert) and, if an error is detected, the error may be used to update the model's training.

The advantages of the disclosed techniques include but are not limited to efficient attribute identification and subsequent attribute-based information extraction from documents that are not represented in any available DBs. Additional advantages include the ability of the trained models to create and populate an attribute DB (or separate attribute DBs for separate clients). For example, if a model (or a set of multiple models) identifies an attribute (a set of attributes) with at least some minimum confidence, the identified attributes may be added to a corresponding DB, which may then be indexed by client, vendor, country, type of a document, language, currency, document and/or date format, language, and/or any other suitable manner, or any combination thereof. Similarly, if an existing DB is updated with a new (e.g., previously unavailable in the DB) attribute, for which historical data is not yet available, the attribute detection models may be used to populate the existing DBs with the new attributes.

In some instances, where a client DB is available, the models may be used for DB verification, elimination of errors from DBs, updates of DBs, and/or the like. For example, an attribute identified with sufficient confidence may be compared to the corresponding attribute available via a client DB. In the instances of a mismatch, the attribute stored in the DB may be corrected or, in some implementations, flagged for additional (e.g., human expert) verification.

As used herein, a “document” may refer to any collection of symbols, such as words, letters, numbers, glyphs, punctuation marks, barcodes, pictures, logos, etc., that are printed, typed, handwritten, stamped, signed, drawn, painted, and the like, on a paper or any other physical or digital medium from which the symbols may be captured and/or stored in a digital image. A “document” may represent a financial document, a legal document, a government form, a shipping label, a purchasing order, an invoice, a credit application, a patent document, a contract, a bill of sale, a bill of lading, a receipt, an accounting document, a commercial or governmental report, or any other suitable document that may have any content of interest to some user. A “document” may include any region, portion, partition, table, table element, etc., that is typed, written, drawn, stamped, painted, copied, and the like. A “document” may be generated using any suitable computing application and may include any computer-readable file that encodes any collection of symbols represented (among other things) via drawing instructions, e.g., any collection of commands, prompts, guidelines and/or the like that, alone or in conjunction with any application, compiler, rendered, and/or the like, inform a computing device how a specific symbol is to be represented on a computer screen, a printed media (e.g., paper), or any other media from which the symbol can be perceived by a human or by another computer. Examples of documents that may include such drawing instructions include (but are not limited to) documents in the Portable Document Format (PDF), DjVu format, electronic publication format (EPUB), Printer Command Language (PCL) format, or any other similar format.

The techniques described herein may involve training one or more neural networks to process images, e.g., to classify inputs among any number of target classes of interest. The neural network(s) may be trained using training datasets that include various electronic documents or portions thereof. During training, neural network(s) may generate a training output for each training input. The training output of the neural network(s) may be compared to a desired target output as specified by the training data set, and the error may be propagated back to various layers of the neural network(s), whose parameters (e.g., the weights and biases of the neurons) may be adjusted accordingly (e.g., using a suitable loss function) to optimize prediction accuracy. Trained neural network(s) may be applied for efficient and reliable performance of any suitable classification tasks.

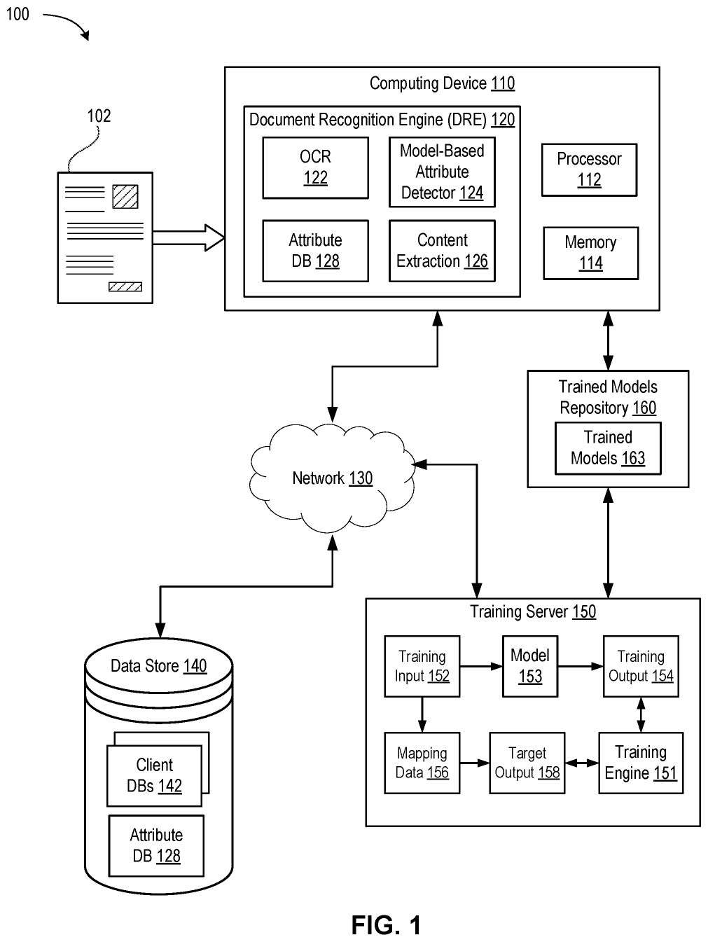

FIG. 1 is a block diagram of an example computer system 100 capable of supporting model-based attribute detection and attribute-based content extraction from electronic documents, in accordance with some implementations of the present disclosure. As illustrated, computer system 100 may include a computing device 110, a data store 140, and a training server 150 connected via a network 130. Network 130 may be a public network (e.g., the Internet), a private network (e.g., a local area network (LAN), wide area network (WAN)), and/or a combination thereof.

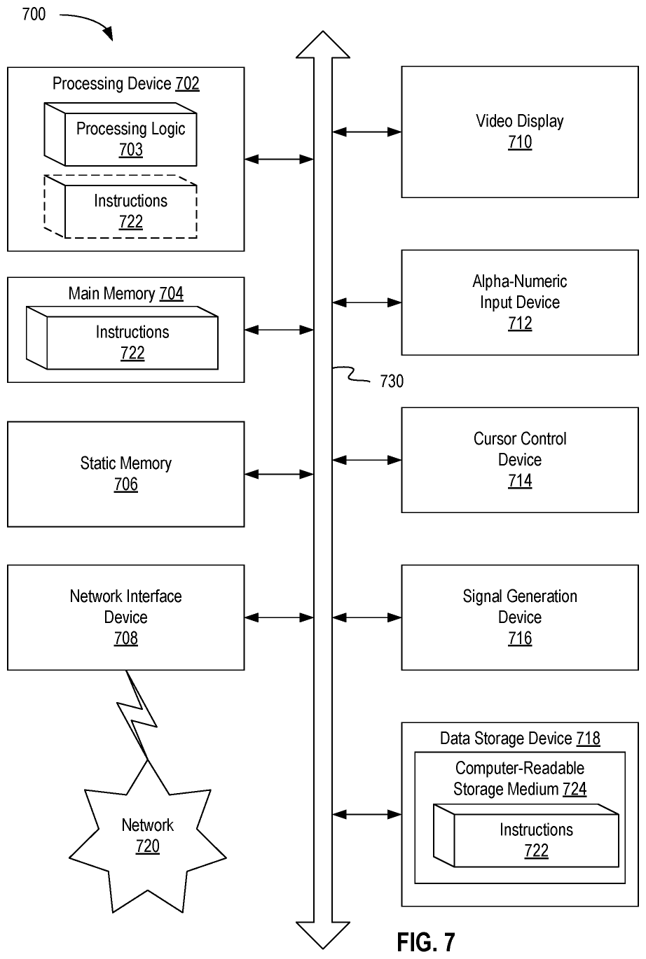

The computing device 110 may be a desktop computer, a laptop computer, a smartphone, a tablet computer, a server, a scanner, or any other suitable computing device capable of performing the techniques described herein. In some implementations, computing device 110 may be (and/or include) one or more computer systems 700 of FIG. 7.

Computing device 110 may receive a document 102 that may include text(s), graphics, table(s), and/or the like. Document 102 may be received in any suitable manner, e.g., locally or over network 130, and may be a letter (printed or electronic), an invoice, a purchasing order, a shipping form, a bill of lading, a government form, a financial form, an accounting form, or any other type of document. In those instances where computing device 110 is a server, a client device (not shown) connected to the server via network 130 may upload a digital copy of document 102 to the server. In the instances where computing device 110 is a client device connected to a server via network 130, computing device 110 may download document 102 from the server or from data store 140.

Document recognition engine (DRE) 120 may perform text recognition of document 102, as described in the instant disclosure. In some implementations, DRE 120 may extract information from document 102 using multiple stages of processing. During the first stage, DRE 120 may apply one or more algorithms of OCR 122 to document 102 and convert images of various symbols and characters in document 102 into recognized letters, glyphs, numerals, punctuation marks, images that do not reduce to letters/numerals (e.g., logos, stamps, etc.), and/or other elemental units of document content. OCR 122 may further group letters into words and further group words and punctuation marks into phrases, sentences, paragraphs, and/or other segments of text. OCR 122 may also group numerals into numbers, associate images with various phrases, sentences, numbers, and/or the like. During a second stage, the OCR output is processed by a model-based attribute detector 124 that uses multiple models to identify attributes of document 102. “Attributes” may include any characteristics of document 102 that may be relevant to understanding of document 102 content and may include a country where document 102 was generated, a country where the originator of document 102 is incorporated or operating, a country where events referenced in document 102 are to take place (e.g., manufacturing, shipment, and/or delivery of goods and/or services). “Attributes” may further include geographical and/or banking attributes of one or more entities (e.g., manufacturing entity, shipping entity, receiving entity, etc.) referenced in document 102, e.g., zip (postal) codes, BIC/SWIFT/IBAN or some other banking information. “Attributes” may also include one or more currencies referenced in the document, e.g., a currency of the country where goods/services are to be produced/delivered, a currency used for payment for goods/services, and/or the like. “Attributes” may also include a specific date format, e.g., “Day.Month.Year,” “Month.Day. Year,” or “Year.Month.Day.” Various other content-relevant information may be included in the attributes of document 102 that are identified by model-based attribute detector 124. During a third stage, the identified attributes may be used by content extraction 126 that extracts any relevant (client-specific) information from document 102. In one non-limiting example, such information may include exact quantities of products being ordered/purchased, contract maturity (e.g., manufacturing and/or delivery) dates, total prices and/or discounts of ordered products, paid or yet to be paid taxes, applicable end-user agreements, specific national and international jurisdiction over the transactions referenced in the documents, and/or the like.

Various components of DRE 120 may have access to instructions stored on one or more tangible, machine-readable storage media of computing device 110 and executable by one or more processors 112 of computing device 110. Processor(s) 112 may include one or more central processing units (CPUs), graphics processing units (GPUs), data processing units (DPUs), parallel processing units (PPUs), application-specific integrated circuits (ASICs), field-programmable gate arrays (FPGA), and/or any combination thereof. Processor(s) 112 supporting operations of DRE 120 may be communicatively coupled to one or more memory devices 114, including read-only memory (ROM), random access memory (RAM), flash memory, static memory, dynamic memory, and/or the like.

In some implementations, DRE 120 may be implemented as a client-based application or a combination of a client component and a server component. In some implementations, DRE 120 may be executed entirely on a client computing device, such as a desktop computer, a server computer, a tablet computer, a smart phone, a notebook computer, a camera, a video camera, or the like. Alternatively, some portion(s) of DRE 120 may be executed on the client computing device (which may receive document 102) while other portion(s) of DRE 120 (e.g., attribute identification and/or content extraction) may be executed on a server device. The server portion may then communicate results of attribute identification and/or content extraction to the client computing device, which may allow a user of the client computing device to perform various operations with document 102, such as text file creation, printing, document parsing, copying portions of document 102, performing DB updates, and/or the like. Alternatively, the server portion may provide the results of attribute identification and/or content extraction to another application. In other implementations, DRE 120 may execute on a server device as an Internet-enabled application accessible via a browser interface. The server device may be represented by one or more computer systems, such as one or more server machines, rackmount servers, workstations, mainframe machines, personal computers (PCs), and so on.

A training server 150 may construct one or more attribute-detection models deployed by DRE 120. Training server 150 may be and/or include a rackmount server, a router computer, a personal computer, a portable digital assistant, a mobile phone, a laptop computer, a tablet computer, a camera, a video camera, a netbook, a desktop computer, a media center, or any combination of the above. In some implementations, training may be performed by a training engine 151. In some implementations, training engine 151 may train models 153 that include neural networks having multiple neurons that perform classification tasks in accordance with various implementations of the present disclosure. Each neuron may receive its input from other neurons or from an external source and may produce an output by applying an activation function to the sum of weighted inputs and a trainable bias value. A neural network may include multiple neurons arranged in layers, including an input layer, one or more hidden layers, and an output layer. Neurons from different layers may be connected by weighted edges. In one illustrative example, all the edge weights may be initially assigned some random values.

Training of various models of model-based attribute detector 124 may include using documents for which ground truth attributes have been identified, e.g., by a human expert or user, as training inputs into the models and changing parameters of the models in the direction that improves attribute recognition by the models.

More specifically, training engine 151 may select one or more documents as training inputs 152 into a specific model 153 being trained and cause model 153 to generate a training output 154. Training engine 151 may compare training output 154 to a target (ground truth) output 158. Target output 158 may be mapped by mapping data 156 to the corresponding training inputs 152. In the instances of supervised training, mapping data 156 may include manual annotations of the documents of training inputs 152, e.g., human developer/user-identified document attributes. In the instances of unsupervised (or self-supervised) training performed using existing DBs of historically processed documents, mapping data 156 may include various indexing/search information that identifies attributes of documents stored in such DBs. During training, training engine 151 finds patterns in the correspondence of training inputs 152 to target outputs 158 and trains models 153 to capture these patterns.

The resulting error, e.g., a difference between the training output of a neural network (or some other machine-learning model 153) and the target output, may be propagated back through the layers of the neural network, and the weights and biases may be adjusted in the way that makes training outputs closer to target outputs 158. This adjustment may be repeated until the error for a particular training input 152 satisfies a predetermined condition (e.g., falls below a predetermined error). Subsequently, a different training input 152 may be selected, a new training output 154 may be generated, and a new series of adjustments may be implemented, and so on, until the model is trained to a sufficient degree of accuracy or until the model reaches its limits determined by the model's architecture.

Various models 153 of model-based attribute detector 124 may include deep neural networks with one or more hidden layers, e.g., convolutional neural networks, recurrent neural networks (RNN), fully connected neural networks, neural networks with attention, transformer-based neural networks, or any combination thereof. The training data, including training inputs 152, target outputs 158, and mapping data 156, may be stored in data store 140. The patterns captured during training may be subsequently used by model-based attribute detector 124 for future attribute identification (classification) during the inference phase. In some implementations, some of the models 153 may include a template-based classifier, a rule-based classifier, a feature-based classifier, and/or some other suitable type of classifier.

Data store 140 may be a persistent storage capable of storing files as well as data structures to perform text recognition in electronic documents, in accordance with implementations of the present disclosure. Data store 140 may be hosted by one or more storage devices, such as main memory, magnetic or optical storage disks, tapes, or hard drives, network-attached storage (NAS), storage area network (SAN), and so forth. Although depicted as separate from the computing device 110, data store 140 may be part of computing device 110. In some implementations, data store 140 may be a network-attached file server, while in other implementations, data store 140 may be some other type of persistent storage, such as an object-oriented database, a relational database, and so forth, that may be hosted by a server machine or one or more different machines coupled via network 130. In some implementations, data store 140 may store one or more client DBs 142. Additionally, data store 140 may store an attribute DB 128 that includes attributes identified by model-based attribute detector 124. In some implementations, attribute DB 128 may be (fully or partially) stored on computing device 110.

Once one or more models 153 have been trained, the resulting trained attribute detection model(s) 163 may be stored in a trained models repository 160 (hosted by any suitable storage devices or a set of storage devices) and provided to model-based attribute detector 124 of computing device 110 (and/or any other computing device) for inference analysis of new documents. For example, computing device 110 may process a new document 102 using model-based attribute detector 124, identify attributes of new document 102, and use the identified attributes to perform target extraction of information from new document 102. The extracted information may be used in any applicable way, including but not limited to further information processing, storing, printing, copying, and so on.

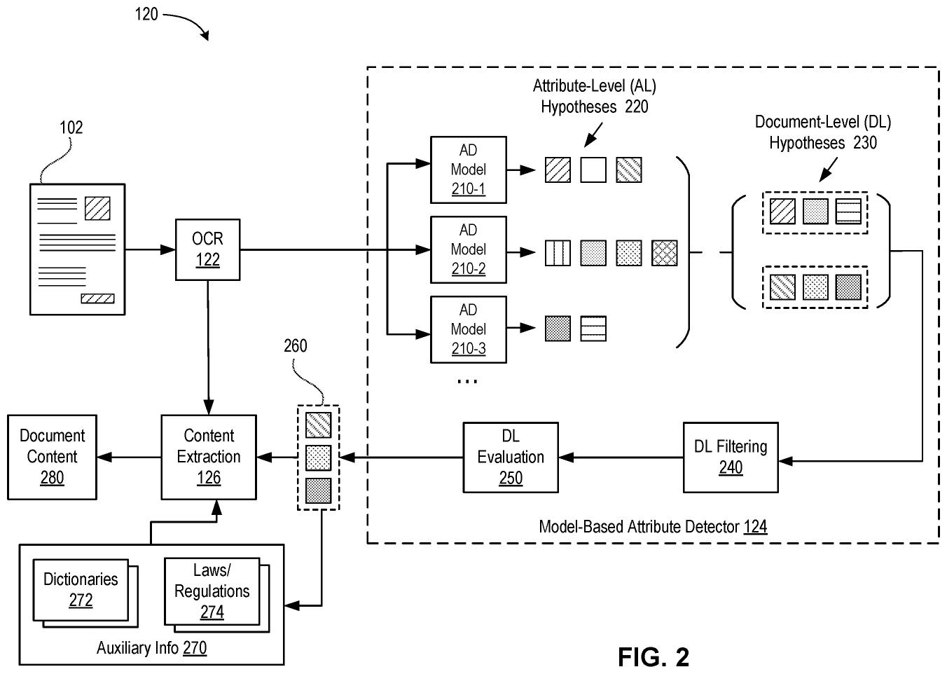

FIG. 2 illustrates example operations of document recognition engine 120 that deploys a module-based attribute detector 124, in accordance with some implementations of the present disclosure. Operations of FIG. 2 may include receiving a document 102 that includes a text content (but may also include a non-text content, e.g., images). Document 102 may be a single-page document or a multi-page document.

Documents 102 processed using operations disclosed in association with FIG. 2 may be structured or unstructured. Structured documents 102 are characterized by fixed locations of various fields, such as commonly used in government forms, credit applications, standard-form purchasing orders, and/or the like. Unstructured documents 102 are characterized by a free form in which various fields, names, entities, etc., appear within the document. For example, an unstructured document may be a purchasing order written in a letter form in which a name of the buying entity, an amount of goods, and a price of goods are stated in locations that are not repeatable or predictable. Similar techniques may be used in the instances of documents 102 that are semi-structured, with some of the fields, names, and entities appearing in fixed locations (e.g., an address of the vendor stated in the top-left corner of the documents) while other fields, names, and entities appearing in arbitrary locations.

A content extraction pipeline for processing of document 102 may start with OCR 122 that recognizes symbols of document 102 and forms symbols into words, numbers, phrases, sentences, and/or other text units. OCR 122 may deploy algorithms that recognize individual typed characters (e.g., letters, numerals, glyphs, etc.), algorithms that recognize handwritten characters, algorithms that recognize whole words (typed or handwritten), or any combinations of such algorithms. OCR 122 algorithms may operate by recognizing symbol patterns, e.g., by comparing shapes and features of symbols to various reference shapes/features. OCR 122 algorithms may use contextual analysis to identify and interpret characters, e.g., based on other (neighboring) characters or words that appear (or are hypothesized to appear) within a certain environment of a given character or a set of characters. In some implementations, OCR 122 may deploy machine learning techniques, e.g., neural network models. In some implementations, OCR 122 may be performed in multiple stages. For example, the first stage may generate coarse text recognition hypotheses, and the second stage may refine coarse hypotheses for more accurate text recognition. In some implementations, the first stage may include placing pixel masks on regions that contain texts with the second stage performing OCR on the masked regions of the document. In some implementations, OCR 122 may include a word beam search that considers sequences that include multiple words instead and evaluates a likelihood of occurrence of coherent word sequences, eliminating character-level errors.

An output of OCR 122 may be a set of recognized characters of document 102 grouped into words, numerals, punctuation marks, etc., which may be separated by spaces or any other indicators of word breaks. Various recognized characters may be indexed by coordinates or any other identifications (e.g., lines and positions within the lines) of locations of the characters within document 102. The OCR output may be stored in a text file, a doc file, a pdf file, a drawing instruction file, or using any other suitable file format.

The OCR output may be used as an input into multiple attribute detection (AD) models 210-1, 210-2, 210-3, and so on. Each of the models 210-j may be trained to identify one or more specific attributes of document 102. In one example non-limiting implementation, AD model 210-1 may be trained to identify a country associated with the issuer of document 102, e.g., a country of operation (or incorporation) of a vendor that issued document 102. AD model 210-2 may be trained to identify a name of the vendor. AD model 210-3 may be trained to identify an address of the vendor. AD model 210-4 (not shown in FIG. 2) may be trained to identify one or more currencies referenced in document 102. For example, multiple currency types may be referenced at various places of document 102, yet the terms of a purchasing order may be stated in a specific currency. AD model 210-5 (not shown in FIG. 2) may be trained to identify a specific date format used in to list relevant dates in document 102. Various other AD models 210-j may be defined, depending on a specific implementation.

AD models 210-j may output various attribute-level (AL) hypotheses 220 that a particular attribute has a specific attribute value associated with document 102. For example, AD model 210-1 may output probabilities p₁, p₂, . . . p_{N} that one of N countries (e.g., from a predefined list) is associated with the issuer of document 102. In some implementations, AD model 210-1 may output logits L₁, L₂, . . . . L_{N} (e.g., logarithms of the corresponding probabilities). The probabilities or logits may be outputted by a softmax classifier layer (e.g., the final layer) of AD model 210-1. As illustrated schematically with differently-shaded squares in the example of FIG. 2, AD model 210-1 has generated three AL hypotheses (e.g., possible vendor countries), AD model 210-2 has generated four AL hypotheses (e.g., possible vendor names), AD model 210-3 has generated two AL hypotheses (e.g., possible date formats in document 102), and so on, each AL hypothesis 220 having a particular probability of occurrence (not stated in FIG. 2 for brevity).

In some implementations, one or more AD models 210-j may be trained to identity values of various fields in document 102, e.g., text fields, such as “name,” “company,” “telephone,” “address,” “vendor name,” “type of payment,” “method of payment,” “type of merchandize,” “quantity of merchandize,” and/or image fields, such as a company logo, a signature, an image of the merchandize used, and/or the like. The model may operate on OCR-identified symbol sequences of document 102. Symbol sequences may include one or more alphanumeric characters (combinable into syllables, words, sentences, etc.) and punctuation marks (e.g., a comma, period, ellipses, etc.). Symbol sequences may include horizontal, vertical, or oblique lines of tables, or three-way or four-way intersections of such lines. Symbol sequences—represented via digital vectors (embeddings)—may be processed by a convolutional neural network having multiple (e.g., tens, hundreds, or more) learned kernels (filters) that capture global context of document 102 and output recalculated vectors. A recalculated vector may represent the same symbol sequence of the original document 102 but may have components (whose number may be the same or different from a number of components of the original vectors) that are recomputed in view of other vectors using the learned kernels. This imparts to the vectors the awareness of the whole document 102 (or at least a substantial portion of it) and improves attribute-identification abilities of the model. In some implementations, re-computation of the vectors may be performed—using separate neural subnetworks—along the vertical dimension of the document and along the horizontal dimension of the document. This imparts to a given recalculated vector (representing a particular symbol sequence) the awareness of other symbol sequences located at different places of the document. In some implementations, the horizontal-pass subnetwork and the vertical-path subnetwork may each be deployed in both directions, e.g., with the horizontal subnetwork performing one or more left-to-right passes and one or more right-to-left passes across the width of the document. Similarly, the vertical subnetwork may perform top-to-bottom and bottom-to-top pass(es) across the height of the document. The recalculated vectors may be processed by another subnetwork, e.g., a fully connected classifier, that forms association hypotheses between the document and various possible attribute values.

In some implementations, one or more AD models 210-j may be trained to determine document attributes by identifying multiple cues within document 102, e.g., multiple pieces of information about the document originator that may be dispersed throughout the document, e.g., an address of the originator printed in the top left corner of the document, the originator's SWIFT account may be stated in the bottom left corner of the document, a country may be mentioned in a body of a letter, and so one. The AD model may form a number of hypotheses associating different portions of information of the document with a particular document attribute, which the model is trained to identify, and may also assign different probabilities to contextual connections between such portions, e.g., between any pair of such portions. A certain (e.g., predetermined) number of such hypotheses having the maximum likelihoods of particular hypothesized associations between two or more contextually connected portions may then be selected as the most likely hypotheses that are then used to identify the most likely attribute values of document attributes.

In some implementations, one or more AD models 210-j may be selected based on the analysis of a layout of document 102. For example, model-based attribute detector 124 may include a pre-classifier model (not shown in FIG. 2) that takes the result of OCR 122 as an input and outputs a layout-based classification of document 102 among a predetermined number of types (clusters) of documents. The pre-classifier may then direct document 102 for attribute detection by a particular set of cluster-specific AD models 210-j. Some of the AD models 210-j, e.g., a date-detection AD model, may be used for multiple (or all) types of documents. Each cluster-specific AD model 210-j may be trained on documents of the respective type (cluster).

In some implementations, one or more AD models 210-j may be named entity recognition (NER) models that deploy natural language processing (NLP) techniques and are trained to identify various prominent features of documents—named entities—such as names, locations, companies, events and products, as well as themes, topics, times, monetary values, percentages, and/or other referenced feature in the text. NER model(s) may deploy grammar algorithms, statistical NLP algorithms, predictive NLP algorithms, and/or any other suitable techniques. NER model(s) may be trained with various techniques of supervised training, e.g., using human-annotated (labeled) data sets that indicate various document attributes. NER model(s) may further be trained using conditional random field training algorithms, maximum entropy training algorithms, and/or other training algorithms, or any combination thereof. In some implementations, NER model(s) may be (or include) rules-based systems that use rules to identify document attributes, e.g., use symbols $, €, £, ¥, etc., to identify information relevant for currency determination. In some implementations, NER model(s) may be (or include) dictionary-based systems that use a dictionary (which may include collections of synonyms) to identify and cross-check document attributes.

Various deployed AD models 210-j may be set with error-tolerance to at least some (empirically determined) degree to account for possible errors that may have occurred during OCR 122 and/or errors that are associated with incorrect identification of attributes. More specifically, AL hypotheses 220 may be formed even when such hypotheses involve one or more inconsistencies. For example, when Slovenia is referenced in some locations of document 102 and Slovakia is references in some other locations of document 102, the corresponding AD model may form a first hypothesis that Slovenia is a country where document 102 has originated and may also form a second hypothesis that document 102 originated in Slovakia, while assigning different probabilities to such mutually exclusive hypotheses.

Generated AL hypotheses 220 may then be used to form document-level (DL) hypotheses 230. For example, each DL hypothesis 230 may represent one possible combination of individual AL hypotheses 220. A probability of a DL hypothesis may be determined in view of probabilities of individual AL hypotheses 220 that make up the respective DL hypothesis 230. For example, as illustrated in FIG. 2, the first (top) DL hypothesis 230 may combine the first AL hypothesis 220 (probability p₁⁽¹⁾) generated by AD model 210-1 with the second AL hypothesis 220 (probability p₂⁽²⁾) generated by AD model 210-2 and further with the second AL hypothesis 220 (probability p₂⁽³⁾) generated by AD model 210-3. Similarly, the second (bottom) DL hypothesis 230 may combine the third AL hypothesis 220 (probability p₃⁽¹⁾) generated by AD model 210-1 with the third AL hypothesis 220 (probability p₃⁽²⁾) generated by AD model 210-2 and further with the first AL hypothesis 220 (probability p₁⁽³⁾) generated by AD model 210-3. The first DL hypothesis 230 may be associated with the combined probability computed as a product of AL probabilities, P₁=p₁⁽¹⁾×p₂⁽²⁾×p₂⁽³⁾. Similarly, the second DL hypothesis 230 may be associated with the combined probability P₂=p₃⁽¹⁾×p₃⁽²⁾×p₁⁽³⁾. Equivalently, the DL hypotheses 230 may be associated with combined logits computed as sums of the respective logits, e.g., Λ₁=L₁⁽¹⁾+L₂⁽²⁾+L₂⁽³⁾ for the first DL hypothesis and Λ₂=L₃⁽¹⁾+L₃⁽²⁾+L₁⁽³⁾ for the second DL hypothesis.

DL hypotheses 230 may then undergo initial DL filtering 240, which may eliminate a subset of DL hypotheses that are unlikely to be true. In one example implementation, DL filtering 240 may include eliminating DL hypotheses 230 having combined probabilities Pⱼ that are below a certain empirically determined threshold P_{T} or having combined logit values Λⱼ that are below a threshold logit value Λ_{T} (e.g., Λ_{T}=ln P_{T}). In some implementations, DL filtering 240 may eliminate DL hypotheses 230 that include manifestly incompatible AL hypotheses 220. For example, one of AL hypotheses 220 outputted by AD model 210-1 may be that the country where the originator (e.g., seller of goods) of document 102 is operating is a European country. Another AL hypothesis 220 outputted by AD model 210-2 may be that the seller of goods is requesting payment in Chinese currency (CNY). DL filtering 240 may then eliminate, as unlikely, a DL hypothesis 230 that combines these AL hypotheses 220. In some implementations, instead of eliminating the corresponding DL hypothesis, DL filtering 240 may discount its probability value Pⱼ (or Λⱼ) by a certain factor indicative of an unlikeness of such association, e.g., Pⱼ→0.1×Pⱼ, in one non-limiting illustrative example.

In some implementations, the hypotheses that remain after DL filtering 240 may be inputted into DL evaluation 250. DL evaluation 250 may be or include a trained classifier that receives a suitable digital representation of the remaining DL hypotheses 230 and determines the most likely DL hypothesis 230 that is used to identify the document attributes 260. In some implementations, DL evaluation 250 may include a trained neural network classifier that receives, from DL filtering 240, a certain (predetermined) number, e.g., M, of most likely DL hypotheses 230, equal to a number of inputs into the neural network classifier, e.g., M inputs Vec₁, Vec₂, . . . . Vec_{M}, each input represented by a respective vector Vecⱼ having N components,

Vecⱼ=(Attribute₁;Attribute₂; . . . ;Attribute_{N}).

Each component of Vecⱼ represents a predicted value of the corresponding attribute, as outputted by the respective AD model 210-j. In some implementations, each component of Vecⱼ may further include a corresponding probability of the attribute value,

Vecⱼ=(Attribute₁,p⁽¹⁾;Attribute₂,p⁽²⁾; . . . ;Attribute_{N},p^{(N)}).

DL evaluation 250 classifier processes such an M×N tensor input and outputs the (final) document attributes 260. DL evaluation 250 classifier may be trained to capture contextual patterns associated with occurrence of different attributes within the same document. For example, DL evaluation 250 may be trained to account that the “Month. Day. Year” date format is positively correlated (but need not be determinative) with documents originated in U.S, the “Day. Year.Month” date format is positively correlated with documents originated in Europe, the “Year.Month.Day” date format is positively correlated with documents originated in China, and/or the like.

Determined document attributes 260 may be used for content extraction 126 that identifies relevant (e.g., to a particular client) document content 280. Some of the document attributes 260 may be used to interpret various fields in document 102. For example, the currency attribute may be used to identify prices of goods/services, amounts of money tendered for the goods/services, discounts received/requested, and/or the like. Date format attributes may be used to determine when an order was made, when the goods/services are expected to be delivered, a duration of a term within which the quoted prices are held firm, and/or the like. Some of the document attributes 260 may additionally be used to select any applicable auxiliary information 270 relevant for content extraction 126. More specifically, an attribute indicating the language of document 102 (e.g., English, Japanese, etc.) may be used to select applicable dictionaries 272 that contain terms relevant for content extraction 126. Similarly, a country where an order was made and/or a country where an order is to be executed may be used to select applicable national and international laws and regulations 274 for these particular countries, e.g., to determine whether correct taxes and/or fees have been paid (or determine an amount of outstanding taxes and/or fees to be paid now or in the future), whether any end-user agreements are to accompany the transaction, and/or the like.

Content extraction 126 may be (or include) a rule-based classifier, a heuristics-based classifier, a machine-learning classifier (e.g., a deep neural network), and/or any combination thereof. Extracted document content 280 may be used in any suitable way, e.g., stored in computer memory, displayed on a user interface, forwarded to any applicable users and/or companies (for execution, monitoring, audit, etc.), and/or the like, or any combination thereof.

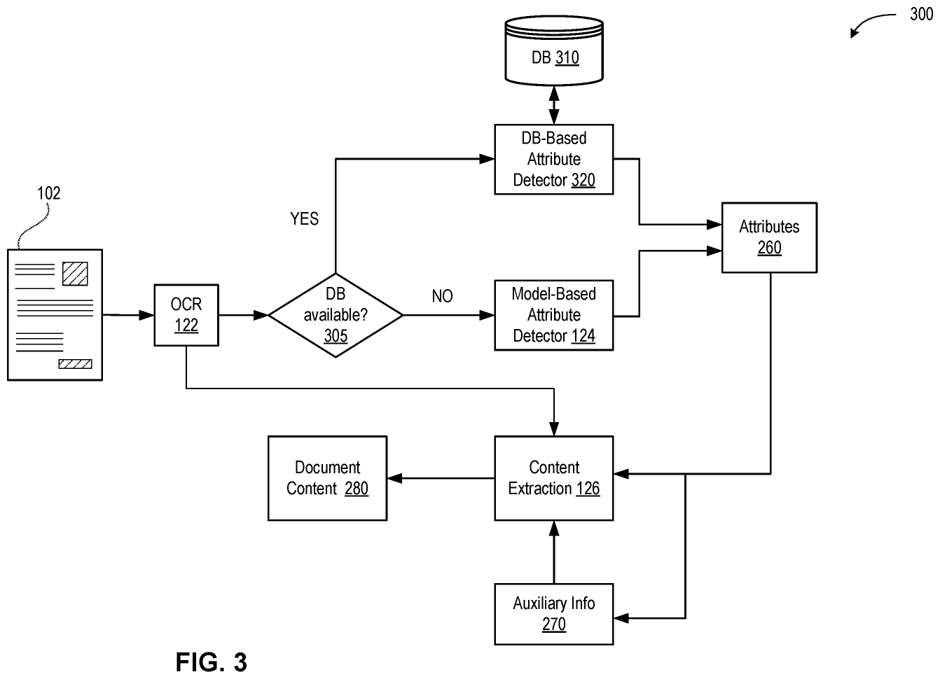

FIG. 3 illustrates operations 300 of a combined database-based and model-based attribute detection for content extraction from electronic documents, in accordance with some implementations of the present disclosure. As illustrated in FIG. 3, document 102 received by (or otherwise available to) a particular client may undergo conditional processing. At decision-making block 305, the document recognition engine may determine if a DB 310 is available for attribute detection of document 102. For example, DB 310 may be a DB that is specific for the client (e.g., client DB 142) or a DB that is available for a particular type of documents. If no suitable DB is available, the document recognition engine may direct document 102 for model-based attribute detector 124 that generates attributes 260 of document 102, e.g., as disclosed in conjunction with FIG. 2. If a suitable DB is available, the document recognition engine may direct document 102 for DB-based attribute detector 320. For example, OCR 122 processing (which may be error-tolerant up to a certain pre-set number of errors of various types) may determine a language of document 102, various features (e.g., address, SWIFT, BIC, IBAN codes, etc.) indirectly indicative of document attributes, values of various fields of document 102, including multiple possibilities for features/values not determined with complete certainty. Such possibilities may be considered as initial hypotheses that DB-based attribute detector 320 then verifies using historical instances of similar documents stored in DB 310. In some implementations, the processing illustrated in FIG. 3 may be performed on a per attribute basis. For example, DB 310 may store historical examples of documents with some of the attributes but may lack instances of other attributes. In such cases, DB-based attributed detector 320 may be used for identification of the former attributes and model-based attribute detector 124 may be used for latter attributes. Additionally, DB-based attributed detector 320 may perform identification of all attributes. The attributes for which DB-based results are available may be used to estimate accuracy/confidence of attributes for which no DB-based results are available. The instances where there is a mismatch between attributes determined using DB 310 and attributes determined using model-based attribute detector 124 may be used for further training of model-based attribute detector 124. The attributes identified by model-based attribute detector 124 or DB-based attribute detector 320 may be used for content extraction 126 (which may include accessing and using auxiliary information 270) to obtain document content 280, which may be performed as disclosed in conjunction with FIG. 2 or in a similar manner.

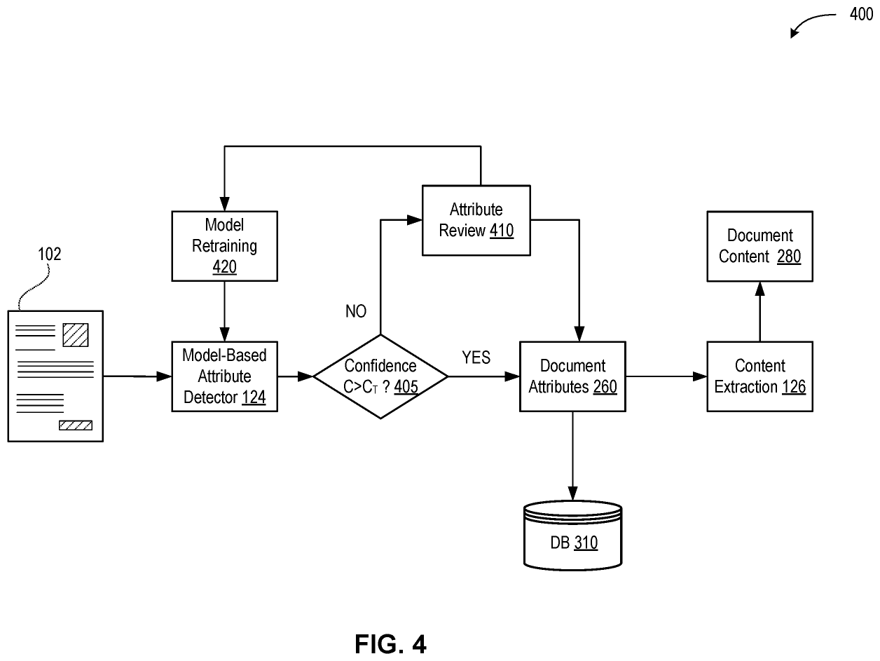

FIG. 4 illustrates example operations 400 of run-time training of model-based attribute detector 124, in accordance with some implementations of the present disclosure. In one implementation, once model-based attribute detector 124 has identified attributes of document 102, a confidence C may be evaluated at decision-making block 405. Confidence C may reflect the probability Pₜₒₚ of the most probable DL hypothesis 230 (with reference to FIG. 2) relative to the probability Pₙₑₓₜ of the second most probable DL hypothesis 230. For example, confidence C may be high (e.g., C≈1) when Pₙₑₓₜ is small, Pₜₒₚ »Pₙₑₓₜ. confidence C may be low (e.g., C≈0) when the two probabilities are not significantly distinct, Pₜₒₚ≈Pₙₑₓₜ. If confidence C is above a certain (e.g., empirically set) threshold confidence C_{T}, the identified attributes may be used for content extraction 126. If confidence C is below the threshold confidence C_{T}, the identified attributes may undergo an attribute review 410, which may include a review by a human user or a DB-based review (if DB data for document 102 is available). If any of the attributes identified by model-based detector 124 are incorrect, the error(s) in the document attributes 260 (corrected after the review) may be used by model retraining 420 to modify parameters of one or more AD models of model-based detector 124 to eliminate (or at least reduce) the errors. Document attributes 260 (identified by model-based attribute detector 124 and/or corrected by attribute review 410) may then be used by content extraction 126 (e.g., as disclosed above in conjunction with FIG. 2) to identify document content 280, including but not limited to a country/name of an originator of the document, one or more countries/currencies referenced in the document, one or more addresses referenced in the document, a language of the document, a date format used in the document, and/or the like.

Additionally, the determined document attributes 260 may be used to populate (update) DB 310. Initially, e.g., for a new client, DB 310 may be empty but may be populated with the document attributes 260 determined for various documents 102 processed for the client by model-based attribute detector 124 (followed by attribute review 410, in applicable instances). DB 310 may then be indexed by vendor, country, type of a document, currency, document and/or date format, language, and/or any other suitable attribute or document property.

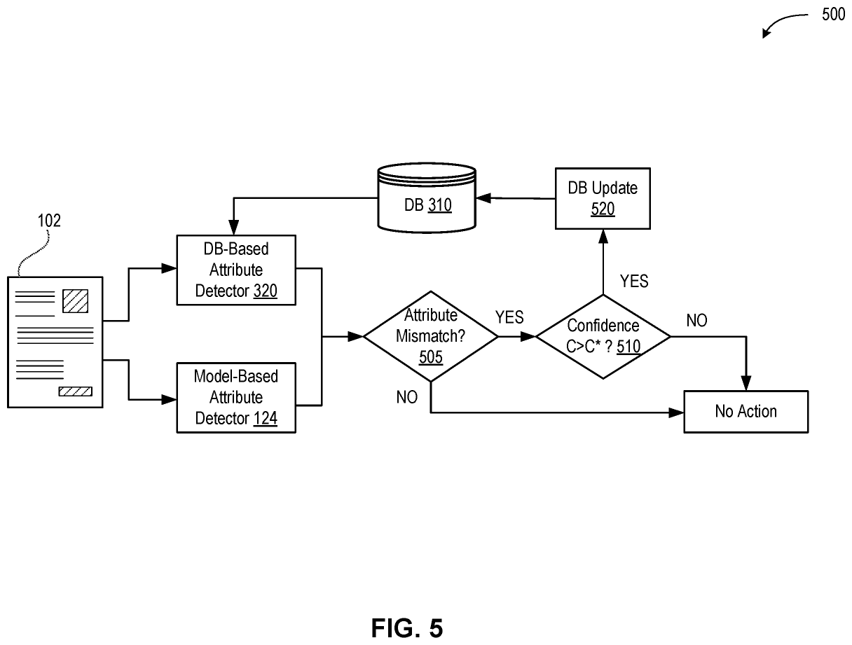

FIG. 5 illustrates example operations 500 of a database verification using a trained model-based attribute detector, in accordance with some implementations of the present disclosure. Once model-based attribute detector 124 has been trained, the trained detector can be used to identify and correct incorrect entries in a client DB 142. More specifically, if document 102 is received by (or otherwise associated with) a client for which a DB of documents is available, document 102 may be directed for processing (after suitable OCR, not shown in FIG. 5 for conciseness) by both DB-based attribute detector 320 and model-based attribute detector 124. The two output sets of document attributes may then be compared to identify any attribute mismatch (block 505), e.g., a difference in identified countries, languages, date formats, and/or the like. If no mismatch is identified, no further action may be taken (other than normal content extraction of the document content). If a mismatch exists, confidence C of model-based attribute detection may be compared, at decision-making block 510, with some (empirically-set) reference confidence C*. Reference confidence C* may be the same or different from threshold confidence Cr used as part of operations 400 of FIG. 4. If confidence is low, C<C*, operations 500 may include no further action, other than normal content extraction of document content (which may use either DB-based attributes or model-based attributes, depending on a set policy). If confidence is high, C>C*, operations 500 may include performing a client DB update 520 to correct one or more attributes incorrectly stored in the client DB 310.

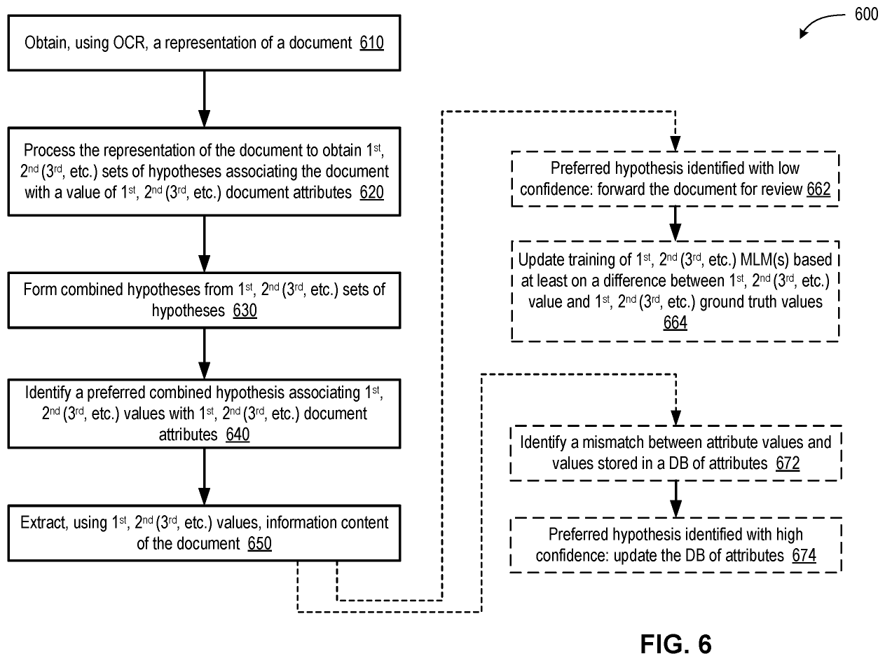

FIG. 6 is a flow diagram illustrating an example method 600 of deploying machine learning models to perform attribute detection for efficient information extraction from documents, in accordance with some implementations of the present disclosure. A computing device, having one or more processing units (e.g., CPUs, GPUs, PPUs, DPUs, etc.) and memory devices communicatively coupled to the processing units, may perform method 600 and/or each of their individual functions, routines, subroutines, or operations. The processing device executing method 600 may be processor 112 of computing device 110 in FIG. 1. In certain implementations, a single processing thread may perform method 600. Alternatively, two or more processing threads may perform method 600, each thread executing one or more individual functions, routines, subroutines, or operations of the methods. In an illustrative example, the processing threads implementing method 600 may be synchronized (e.g., using semaphores, critical sections, and/or other thread synchronization mechanisms). Alternatively, the processing threads implementing method 600 may be executed asynchronously with respect to each other. Various operations of method 600 may be performed in a different order compared with the order shown in FIG. 6. Some operations of method 600 may be performed concurrently with other operations. Some operations may be optional.

At block 610, method 600 may begin with obtaining a document. Documents may be in a structured form (with information content captured in predetermined fields), partially structured form (with some information captured in predetermined fields and some information present in a free text form), or unstructured form (with all or most information content present in a free text form). Document may be subjected to one or more OCR algorithms that identify symbol sequences (words, numbers, elements of tables, etc.) of the document. The output of the OCR may be used to obtain a suitable representation of the document. The representation of the document may include a recognized text of the document, e.g., in ASCII format or some other suitable format. In some implementations, the recognized text may be further represented via a plurality of computer-generated vectors, each vector associated with a respective symbol sequence. In some implementations, computer-generated vectors (embeddings) may not be ascertainable or perceivable by a human but may identify document's properties to a computer-implemented process or software.

At block 620, method 600 may include processing the representation of the document to obtain a first set of hypotheses (e.g., AL hypotheses 220 generated by AD model 210-1). Each hypothesis may associate the document with a respective value of a first document attribute (e.g., a first document attribute “vendor” may have different values in different hypotheses, corresponding to various names of companies referenced in the document). Obtaining the hypotheses may be performed using complex computer processing, e.g., based on computer-identified heuristics and/or natural language programming. In some implementations, processing the representation of the document to obtain the first set of hypotheses may be performed using a first machine learning model (MLM), e.g., AD model 210-1 in FIG. 2. Similarly, method 600 may include processing the representation of the document to obtain a second set of hypotheses, each hypothesis associating the document with a respective value of a second (third, etc.) document attribute (e.g., country, language, date format, and so on). In some implementations, processing the representation of the document to obtain the second set of hypotheses may be performed using a second (third, etc.) MLM (e.g., AD model 210-2, AD model 210-3, and so on).

In some implementations, processing of the representation of the document using the first MLM and the second (third, etc.) MLM may be responsive to identifying that a database of attributes is unavailable for a type of documents that is associated with the document (e.g., no DB of invoices exists for client “Paragon X,” the recipient of the invoice).

In some implementations, the first MLM or the second (third, etc.) MLM includes a convolutional neural network (CNN). In some implementations, the CNN may include multiple subnetworks, e.g., a first subnetwork that processes the plurality of vectors along a horizontal dimension of the document and a second subnetwork that processes the plurality of vectors along a vertical dimension of the document.

At block 630, method 600 may include forming a plurality of combined hypotheses (e.g., DL hypotheses 230), each combined hypothesis combining a hypothesis of the first set and a hypothesis of the second (third, etc.) set.

At block 640, method 600 may include identifying a preferred hypothesis (e.g., a most probable hypothesis) from the plurality of combined hypotheses. The preferred hypothesis may associate a first value with the first document attribute and a second value with the second document attribute (and may further associate a third, etc., value with the third, etc., document attribute). In some implementations, the first document attribute may include a country associated with an originator of the document, a name of the originator of the document, a country referenced in the document, an address referenced in the document, a language of the document, a date format used in the document, and/or the like. In some implementations, identifying the preferred hypothesis may include processing, using a hypotheses classifier model, the plurality of combined hypotheses. The classifier model may include a neural network classifier, a rules-based classifier, a heuristics-based classifier, a support vector classifier, a cluster-based classifier, and/or the like, or some combination thereof.

At block 650, method 600 may include extracting, using the first value and the second (third, etc.) value, information content of the document. In some implementations, extracting the information content of the document may include using an auxiliary information (e.g., dictionaries, policies, regulations, and/or the like) that is selected based on at least one of the first value of the first document attribute or the second (third, etc.) value of the second document attribute.

In some implementations, method 600 may further include additional operations indicated with dashed blocks in FIG. 6. For example (e.g., as disclosed in conjunction with FIG. 4), at block 662, method 600 may forward the document for review responsive to the preferred hypothesis being identified with a confidence below a threshold confidence. At block 664, method 600 may continue with updating training of at least the first MLM (but may also include updating training of the second, third, etc., MLMs) based at least on a difference between the first value and a first ground truth value obtained during the review.

As another example (e.g., as disclosed in conjunction with FIG. 5), at block 672, method 600 may include identifying, using a database of attributes, a database value associated with the first document attribute. At block 674, responsive to the first value being identified with a confidence above a reference confidence, method 600 may continue with updating the database value to the first value.

FIG. 7 depicts an example computer system 700 that can perform any one or more of the methods described herein, in accordance with some implementations of the present disclosure. The computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a set-top box (STB), a Personal Digital Assistant (PDA), a mobile phone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The exemplary computer system 700 includes a processing device 702, a main memory 704 (e.g., read-only memory (ROM), flash memory, dynamic random access memory (DRAM) such as synchronous DRAM (SDRAM)), a static memory 706 (e.g., flash memory, static random access memory (SRAM)), and a data storage device 718, which communicate with each other via a bus 730.

Processing device 702 (which can include processing logic 703) represents one or more general-purpose processing devices such as a microprocessor, central processing unit, or the like. More particularly, the processing device 702 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 may also be one or more special-purpose processing devices such as an application specific integrated circuit (ASIC), a field programmable gate array (FPGA), a digital signal processor (DSP), network processor, or the like. The processing device 702 is configured to execute instructions 722 for implementing various modules and components of DRE 120 of FIG. 1 and to perform the operations discussed herein, operations of method 600 of deploying machine learning models to perform attribute detection for efficient information extraction from documents, as disclosed in conjunction with FIG. 6.

The computer system 700 may further include a network interface device 708. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 716 (e.g., a speaker). In one illustrative example, the video display unit 710, the alphanumeric input device 712, and the cursor control device 714 may be combined into a single component or device (e.g., an LCD touch screen).

The data storage device 718 may include a computer-readable storage medium 724 on which is stored the instructions 722 embodying any one or more of the methodologies or functions described herein. The instructions 722 may also reside, completely or at least partially, within the main memory 704 and/or within the processing device 702 during execution thereof by the computer system 700, the main memory 704 and the processing device 702 also constituting computer-readable media. In some implementations, the instructions 722 may further be transmitted or received over a network 720 via the network interface device 708.

While the computer-readable storage medium 724 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Although the operations of the methods herein are shown and described in a particular order, the order of the operations of each method may be altered so that certain operations may be performed in an inverse order or so that certain operations may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “analyzing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. Furthermore, the terms “first,” “second,” “third,” “fourth,” etc. as used herein are meant as labels to distinguish among different elements and may not necessarily have an ordinal meaning according to their numerical designation.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure.

What is claimed is:

1. A method comprising:
processing a representation of a document to obtain a first set of hypotheses each associating the document with a respective value of a first document attribute;
processing the representation of the document to obtain a second set of hypotheses each associating the document with a respective value of a second document attribute;
forming a plurality of combined hypotheses each comprising at least a hypothesis of the first set and a hypothesis of the second set;
identifying a preferred hypothesis from the plurality of combined hypotheses, the preferred hypothesis associating a first value with the first document attribute and a second value with the second document attribute; and
extracting, using the first value and the second value, information content of the document.

2. The method of claim 1, wherein the representation of the document is obtained using one or more optical character recognition (OCR) algorithms.

3. The method of claim 1, wherein the first document attribute comprises at least one of:
a country associated with an originator of the document,
a name of the originator of the document,
a country referenced in the document,
a currency referenced in the document,
an address referenced in the document,
a language of the document, or
a date format used in the document.

4. The method of claim 1, wherein identifying the preferred hypothesis comprises:
processing, using a hypotheses classifier model, the plurality of combined hypotheses.

5. The method of claim 1, wherein processing the representation of the document to obtain the first set of hypotheses is performed using a first machine learning model (MLM), and wherein processing the representation of the document to obtain the second set of hypotheses is performed using a second MLM.

6. The method of claim 5, wherein the representation of the document comprises a plurality of vectors each associated with a respective symbol sequence of a plurality of symbol sequences of the document, and wherein at least one of the first MLM or second MLM comprises a first subnetwork and a second subnetwork, wherein the first subnetwork processes the plurality of vectors along a horizontal dimension of the document and the second subnetwork processes the plurality of vectors along a vertical dimension of the document.

7. The method of claim 5, further comprising:
responsive to the preferred hypothesis being identified with a confidence below a threshold confidence, forwarding the document to a review; and
updating training of at least the first MLM based at least on a difference between the first value and a first ground truth value obtained during the review.

8. The method of claim 1, further comprising:
identifying, using a database of attributes, a database value associated with the first document attribute; and
responsive to the first value being identified with a confidence above a reference confidence, updating the database value to the first value.

9. The method of claim 1, wherein processing of the representation of the document to obtain the first set of hypotheses and the second set of hypotheses is responsive to identifying that a database of attributes is unavailable for a type of documents that is associated with the document.

10. The method of claim 1, wherein extracting the information content of the document comprises:
using an auxiliary information that is selected based on at least one of the first value of the first document attribute or the second value of the second document attribute.

11. The method of claim 1, wherein at least some of the information content is present in the document in an unstructured form.

12. A system comprising:
a memory; and
a processing device communicatively coupled to the memory, the processing device to:
process a representation of a document to obtain a first set of hypotheses each associating the document with a respective value of a first document attribute;
process the representation of the document to obtain a second set of hypotheses each associating the document with a respective value of a second document attribute;
form a plurality of combined hypotheses each comprising at least a hypothesis of the first set and a hypothesis of the second set;
identify a preferred hypothesis from the plurality of combined hypotheses, the preferred hypothesis associating a first value with the first document attribute and a second value with the second document attribute; and
extract, using the first value and the second value, information content of the document.

13. The system of claim 12, wherein the representation of the document is obtained using one or more optical character recognition (OCR) algorithms.

14. The system of claim 12, wherein the first document attribute comprises at least one of:
a country associated with an originator of the document,
a name of the originator of the document,
a country referenced in the document,
a currency referenced in the document,
an address referenced in the document,
a language of the document, or
a date format used in the document.

15. The system of claim 12, wherein to identify the preferred hypothesis, the processing device is to:
process, using a hypotheses classifier model, the plurality of combined hypotheses.

16. The system of claim 12, wherein to process the representation of the document to obtain the first set of hypotheses and the second set of hypotheses, the processing device is to use a machine learning model (MLM), wherein the representation of the document comprises a plurality of vectors each associated with a respective symbol sequence of a plurality of symbol sequences of the document, and wherein at least one of the MLM comprises a first subnetwork and a second subnetwork, the first subnetwork processing the plurality of vectors along a horizontal dimension of the document and the second subnetwork processing the plurality of vectors along a vertical dimension of the document.

17. The system of claim 16, wherein the processing device is to process the representation of the document to obtain the first set of hypotheses and the second set of hypotheses responsive to identifying that a database of attributes is unavailable for a type of documents that is associated with the document.

18. The system of claim 12, wherein extracting the information content of the document comprises:
using an auxiliary information that is selected based on at least one of the first value of the first document attribute or the second value of the second document attribute.

19. A non-transitory computer-readable memory storing instructions that, when executed by a processing device, cause the processing device to perform operations comprising:
processing a representation of a document to obtain a first set of hypotheses each associating the document with a respective value of a first document attribute;
processing the representation of the document to obtain a second set of hypotheses each associating the document with a respective value of a second document attribute;
forming a plurality of combined hypotheses each comprising at least a hypothesis of the first set and a hypothesis of the second set;
identifying a preferred hypothesis from the plurality of combined hypotheses, the preferred hypothesis associating a first value with the first document attribute and a second value with the second document attribute; and
extracting, using the first value and the second value, information content of the document.

20. The non-transitory computer-readable memory of claim 19, wherein processing of the representation of the document to obtain the first set of hypotheses and the second set of hypotheses is responsive to identifying that a database of attributes is unavailable for a type of documents that is associated with the document.
